(19) United States
(12) Patent Application Publication
(10) Pub. No.: US 2026/0034815 A1
(43) Pub. Date: Feb. 5, 2026

(54) IMAGE FORMING SYSTEM, DETERMINING METHOD, AND MEDIUM

(71) Applicant: BROTHER KOGYO KABUSHIKI KAISHA, Nagoya (JP)

(72) Inventors: ISAO FUKUCHI, Gifu (JP); YUTA OSHITANI, Nagoya (JP)

(73) Assignee: BROTHER KOGYO KABUSHIKI KAISHA, Nagoya (JP)

(21) Appl. No.: 19/285,019

(22) Filed: Jul. 30, 2025

(30) Foreign Application Priority Data
Jul. 31, 2024 (JP) 2024-124746
Feb. 14, 2025 (JP) 2025-022484

(51) Int. Cl. B41J 29/38; B41J 2/045

(52) U.S. Cl. CPC B41J 29/38; B41J 2/04503; B41J 2/04586

(57) ABSTRACT

An image forming system including: a head; a carriage moving mechanism including a carriage, a motor, and a transmission; a motor driver; an encoder; and a controller is provided. The controller is configured to: identify, regarding a certain period being each of the plurality of periods, an index value regarding abnormality of the image forming system based on time series data of a moving velocity, a physical amount related to the moving velocity, or an operation amount observed in a moving control of the carriage in the certain period; and determine an end of a service life of the image forming system or a remaining amount of the service life of the image forming system based on a change of the index value over the plurality of periods.

### REFERENCE TO RELATED APPLICATIONS

This application claims priority from Japanese Patent Application No. 2024-124746 filed on Jul. 31, 2024 and Japanese Patent Application No. 2025-022484 filed on Feb. 14, 2025. The entire contents of the priority applications are incorporated herein by reference.

### BACKGROUND ART

An image forming system in which a plurality of devices in the system is controlled based on a master signal is known. As a technique related to this image forming system, a technique of diagnosing a failure of each of the plurality of devices by performing, in real time, frequency analysis of a fluctuation amount of a rotation velocity calculated from comparison between the master signal and a feedback signal of each of the plurality of devices is known.

Further, an image forming system in which an image is formed on a recording medium such as paper or clothing by ejecting ink from a recording head is known. In this image forming system, various factors such as deterioration of a motor, soiling by the ink, and wearing of a movable component cause an operational abnormality. In a known technique, system maintenance such as replacement of component and cleaning is performed so that this type of image forming system can be continuously used.

### SUMMARY

In the known technique, however, a time when the image forming system would fail cannot be predicted. Accordingly, the system maintenance cannot be performed at an appropriate time, and thus the down time of the system occurs or is prolonged, in some cases.

In view of such a situation, providing a technique capable of predicting, in an image forming system configured to eject ink onto a recording medium to form an image, the time when the image forming system would fail is desirable.

According to an aspect of the present disclosure, an image forming system is provided. The image forming system includes: a head, a carriage moving mechanism, a motor driver, an encoder, and a controller.

The carriage moving mechanism includes: a carriage on which the head is mounted; a motor; and a transmission connecting the carriage and the motor.

The controller is configured to perform moving control of the carriage by inputting an operation amount for moving the carriage in the main scanning direction at a target velocity into the motor driver based on a moving velocity of the carriage detected based on the encoder signal output from the encoder. The motor driver is configured to apply a driving power based on the operation amount to the motor so as to drive the motor.

The controller is further configured to identify, regarding a certain period being each of the plurality of periods, an index value regarding abnormality of the image forming system based on time series data of the moving velocity, a physical amount related to the moving velocity, or the operation amount observed in the moving control of the carriage in the certain period. The controller is configured to determine an end of a service life of the image forming system or a remaining amount of the service life of the image forming system based on a change of the index value over the plurality of periods.

According to the image forming system, time when the image forming system would fail can be accurately predicted based on the determined end of the service life or the determined remaining amount of the service life.

According to another aspect of the present disclosure, a determining method for determining an end of a service life of an image forming system or a remaining amount of the service life of the image forming system may be provided. The image forming system includes: a head; a carriage moving mechanism; a motor driver; an encoder; and a controller.

The carriage moving mechanism includes: a carriage on which the head is mounted; a motor; and a transmission connected to the carriage and the motor.

The controller is configured to perform moving control of the carriage by inputting an operation amount for moving the carriage in the main scanning direction at a target velocity into the motor driver based on a moving velocity of the carriage detected based on the encoder signal from the encoder. The motor driver is configured to apply a driving power based on the operation amount to the motor so as to drive the motor.

The determining method may include obtaining, regarding a certain period being each of the plurality of periods, time series data of the moving velocity, a physical amount related to the moving velocity, or the operation amount observed in the moving control of the carriage in the certain period, and identifying an index value regarding abnormality of the image forming system based on the time series data. The determining method may further include determining the end of the service life of the image forming system or the remaining amount of the service life of the image forming system based on a change of the index value over the plurality of periods.

By using the determining method, time when the image forming system would fail can be accurately predicted based on the determined end of the service life or the determined remaining amount of the service life.

According to yet another aspect of the present disclosure, a non-transitory and computer-readable medium storing a computer program for causing a computer to execute the determining method described above may be provided.

### BRIEF DESCRIPTION OF DRAWINGS

FIG. 1 is a diagram depicting a mechanical configuration of an image forming system.

FIG. 2 is a diagram depicting an electric configuration of the image forming system.

FIG. 3 is a flowchart depicting a job-related process executed by a main controlling part.

FIG. 4 is a graph of time versus velocity depicting a temporal change in a carriage velocity.

FIGS. 5A and 5B are flowcharts depicting a determination-related process executed by the main controlling part.

FIG. 6 is a graph of time versus index value depicting changes in an index value.

FIG. 7 is a view describing a method for identifying a cause of an abnormality based on a frequency spectrum.

FIG. 8 is a view describing a method for identifying an index value based on a frequency spectrum in the second embodiment.

FIGS. 9A and 9B are flowcharts depicting a determination-related process according to the second embodiment.

FIG. 10 is a graph of time versus index value depicting changes in an index value in the second embodiment.

FIG. 11 is a diagram describing the determination of a remaining service life by using a server apparatus.

### DESCRIPTION

In the following, an exemplary embodiment of the present disclosure will be described, with reference to the drawings.

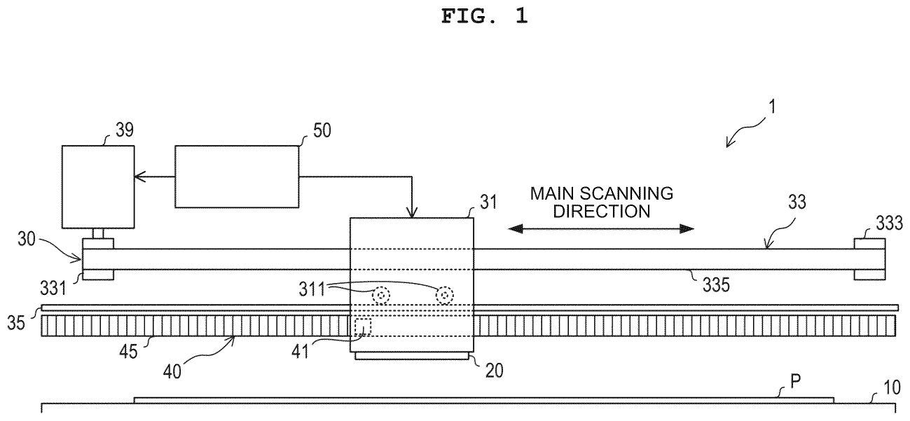

An image forming system 1 of the present embodiment depicted in FIG. 1 is an ink-jet printer which forms an image on an object P, as a recording medium placed on a platen 10, by ejecting an ink onto the object P. Specifically, the object P is a garment. In other words, the image forming system 1 is configured as a garment printer.

In addition to the platen 10, the image forming system 1 includes a recording head 20, a carriage moving mechanism 30, a linear encoder 40, and controller 50. The recording head 20 is an ink-jet head and is configured to eject an ink onto the object P which is placed to face the recording head 20. The recording head 20 has a plurality of nozzle arrays each including nozzles from which ink droplets are ejected.

The carriage moving mechanism 30 includes a carriage 31, a belt mechanism 33, a guide rail 35, and a carriage (CR) motor 39. The recording head 20 is mounted on the carriage 31. The belt mechanism 33 is disposed along the main scanning direction.

The belt mechanism 33 includes a driving pulley 331, a driven pulley 333, and an endless belt 335. The belt mechanism 33 functions as a power transmission system which converts the rotational motion of the CR motor 39 into the translational motion of the carriage 31.

The endless belt 335 is disposed along the main scanning direction and is wound to span between the driving pulley 331 and the driven pulley 333. The driving pulley 331 is disposed at one end in the main scanning direction of the guide rail 35. The driven pulley 333 is disposed at the other end in the main scanning direction of the guide rail 35.

The CR motor 39 is connected to the driving pulley 331. The CR motor 39 is, for example, a DC motor. The driving pulley 331 rotates in conjunction with the rotation of the CR motor 39. The endless belt 335 and the driven pulley 333 rotate in conjunction with the rotation of the driving pulley 331.

The carriage 31 is fixed to the endless belt 335 and moves translationally in conjunction with the rotation of the endless belt 335. In other words, the carriage 31 receives the power from the CR motor 39 via the endless belt 335 and moves translationally.

The carriage 31 is connected to the guide rail 35 extending in the main scanning direction. The guide rail 35 makes contact with the carriage 31, and restricts the movement of the carriage 31 to the main scanning direction. The carriage 31 has rollers 311 which run on the guide rail 35 and which are disposed rotatably in the carriage 31.

The rollers 311 correspond to an interface between the guide rail 35 and the carriage 31. In a case where the carriage 31 moves translationally in conjunction with the rotation of the endless belt 335, the rollers 311 run on the guide rail 35 due to rolling movement of the rollers 311 in a state that the rollers 311 are in contact with the guide rail 35. The carriage 31 moves straight along the guide rail 35 in the main scanning direction under the action of the force from the endless belt 335 in a state that the movement of the carriage 31 is restricted by the guide rail 35.

The carriage 31 moves in the positive or negative direction of the main scanning direction in accordance with the rotational direction of the endless belt 335. In other words, the carriage 31 reciprocates in the main scanning direction in accordance with switching of the rotational direction of the endless belt 335.

The linear encoder 40 includes an optical sensor 41 and an encoder scale 45, and functions as an incremental optical linear encoder. The linear encoder 40 is used to observe the position and a moving velocity (hereafter simply referred to as “velocity”) in the main scanning direction of the carriage 31.

As depicted in FIG. 1, the encoder scale 45 is disposed to extend in the main scanning direction, along a moving route of the carriage 31. The encoder scale 45 includes gradations positioned with predetermined spacing in the longitudinal direction, of the encoder scale 45, corresponding to the main scanning direction.

The optical sensor 41 is fixed to the carriage 31 and moves together with the carriage 31 in the main scanning direction. Namely, the optical sensor 41 moves relative to the encoder scale 45. In a case where the carriage 31 moves in the main scanning direction, the optical sensor 41 reads the gradations of the encoder scale 45 and outputs an encoder signal in accordance with a positional change in the main scanning direction of the carriage 31.

Specifically, the optical sensor 41 outputs a pulse signal as the encoder signal each time the carriage 31 moves by a predetermined amount in the main scanning direction. The encoder signal includes, for example, an A-phase signal and a B-phase signal of which phases are shifted by 90 degrees from each other.

Based on the position and the velocity of the carriage 31 in the main scanning direction detected based on the encoder signal, the controller 50 controls the movement of the carriage 31 and an ejecting operation of the ink by the recording head 20.

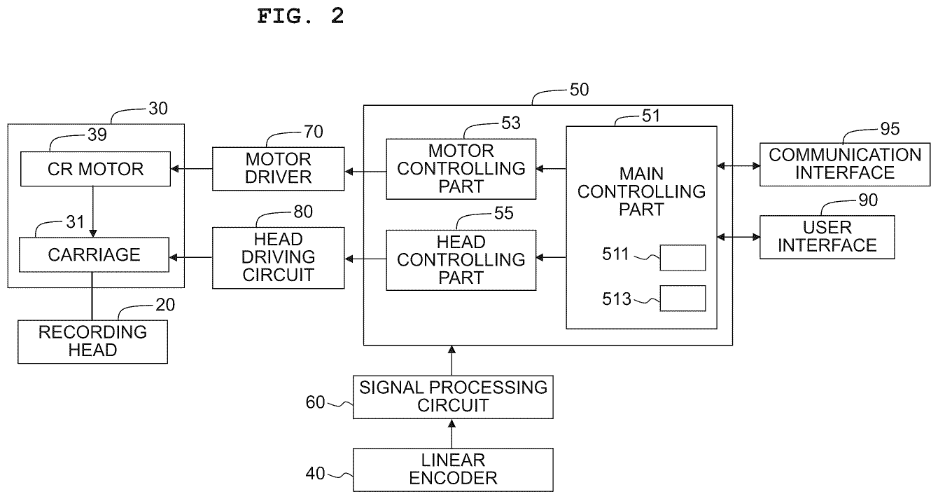

As depicted in FIG. 2, the image forming system 1 includes a signal processing circuit 60, a motor driver 70, a head driving circuit 80, a user interface 90, and a communication interface 95 each of which is disposed around the controller 50.

The signal processing circuit 60 is configured to detect the position and the velocity of the carriage 31 in the main scanning direction, based on the encoder signal input from the linear encoder 40. In the following, the position and the velocity V of the carriage 31 detected by the signal processing circuit 60 are also expressed as a detected position and a detected velocity V.

The motor driver 70 is configured to drive, based on a voltage command value U input from the controller 50, the CR motor 39 by applying a driving power corresponding to the voltage command value U to the CR motor 39. The head driving circuit 80 is configured to drive the recording head 20 based on a command signal from the controller 50 to cause the recording head 20 to execute the ejecting operation of the ink.

The user interface 90 has an operation part (not depicted in the drawings) configured to receive an operation from the user and a display part (not depicted in the drawings) configured to display various kinds of information to the user. The operation part may be, for example, a touch panel disposed on a display screen of the display part. The display part may be, for example, a liquid crystal display.

The communication interface 95 is configured so that the communication interface 95 is capable of communicating with an external device. The image forming system 1 is configured to obtain image data from the external device via the communication interface 95, and to form an image based on the obtained image data on the object P.

The controller 50 has a main controlling part 51, a motor controlling part 53, and a head controlling part 55, as depicted in FIG. 2. The motor controlling part 53 is configured to control the CR motor 39 to thereby control the position and the velocity of the carriage 31 in the main scanning direction.

For example, the motor controlling part 53 performs motor control to move the carriage 31 at a constant velocity at a target velocity Vr in the main scanning direction in a case where an image is being formed on the object P. This motor control is performed to control the landing position of the ink on the object P.

Specifically, the motor controlling part 53 is configured to perform feedback control to make the velocity of the carriage 31 the target velocity Vr, based on the detected velocity V of the carriage 31 obtained from the signal processing circuit 60. The feedback control may be, for example, the PID control.

The motor controlling part 53 calculates, for example, the voltage command value U in accordance with a deviation E=Vr−V between the detected velocity V of the carriage 31 and the target velocity Vr, and inputs the voltage command value U to the motor driver 70. The voltage command value U corresponds to an operation amount U with respect to the CR motor 39 for moving the carriage 31 in the main scanning direction at the target velocity Vr.

The motor driver 70 is configured to apply, to the CR motor 39, a driving current (in other words, driving power) corresponding to the voltage command value U input from the motor controlling part 53 by, for example, the PWM (Pulse Width Modulation) driving. Accordingly, the velocity of the carriage 31 is controlled to the target velocity Vr.

The head controlling part 55 inputs a control signal for controlling the ejecting operation of the ink by the recording head 20 to the head driving circuit 80, based on the detected position of the carriage 31 obtained via the signal processing circuit 60.

In addition, the main controlling part 51 is configured to receive a command from the user input via the user interface 90, to monitor the state of the image forming system 1, and to display information describing the state of the image forming system 1 to the user via the user interface 90 as necessary.

According to the present embodiment, characteristically, the main controlling part 51 is configured to determine a remaining service life, which is a remaining time before the image forming system 1 might fail. The main controlling part 51 is further configured to provide, to a user via the user interface 90, information urging the user to perform maintenance such as replacement of component, cleaning, etc., based on the remaining service life and before the image forming system 1 fails. In the following, the details of a process related to the determination of the remaining service life will be described.

The main controlling part 51 is configured to record, each time a print job is performed, a maximum value VP of the velocity V of the carriage 31, and to predict a timing at which the maximum value VP reaches a threshold value, based on changes of the maximum value VP. The main controlling part 51 is configured to determine the predicted timing as the end of the service life of the image forming system 1 and to determine a time from the current time to the predicted timing as the remaining amount of the service life (hereinafter, simply referred to as “remaining service life”). In a case where the remaining service life becomes a set value or less, the main controlling part 51 notifies the user of the remaining service life via the user interface 90, and urges the user to perform maintenance.

The main controlling part 51 may include a processor 511 and a memory 513. The processor 511 executes various functions, including the determination of the remaining service life, by executing a process in accordance with a computer program stored in the memory 513. The memory 513 may include a RAM and a NVRAM.

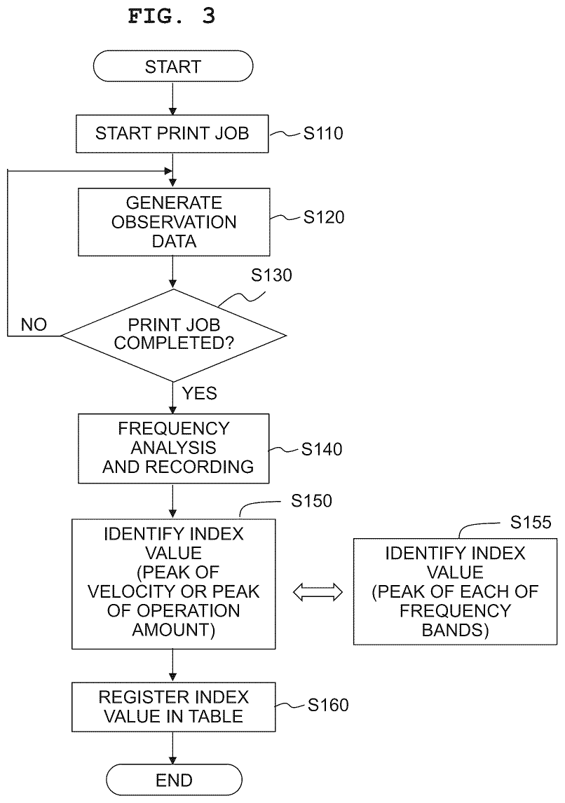

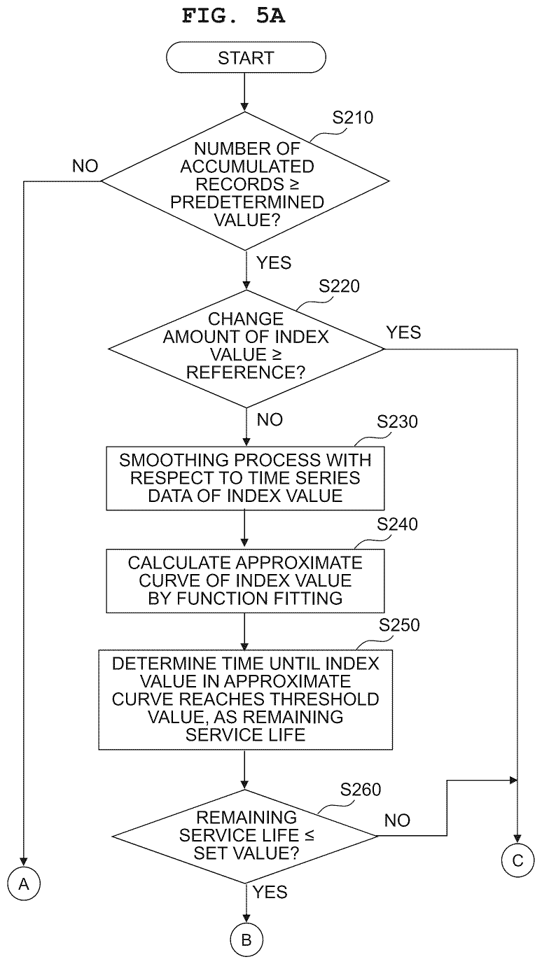

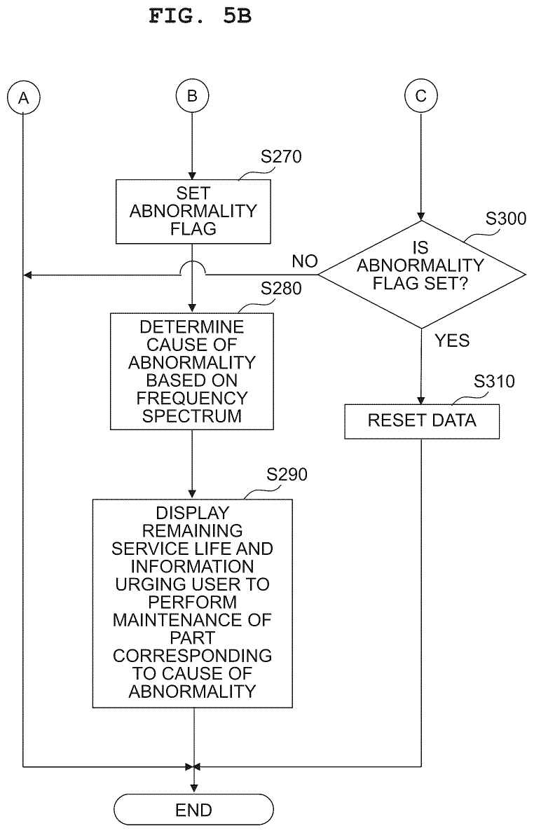

A job-related process (FIG. 3) and a determination-related process (FIGS. 5A and 5B) executed by the main controlling part 51 described below can be understood that those processes are processes executed by the processor 511 in accordance with the computer program stored in the memory 513.

Specifically, the main controlling part 51 executes the job-related process depicted in FIG. 3 in a case where a start condition of the print job is satisfied. For example, the main controlling part 51 executes the job-related process in a case where an execution command for the print job is input via the user interface 90.

In a case where the main controlling part 51 starts the job-related process, the main controlling part 51 starts the print job (step S110). In the print job, the main controlling part 51 cooperates with the motor controlling part 53 and the head controlling part 55 so as to control the movement of the carriage 31 and the ink ejecting operation by the recording head 20, and forms an image based on specified image data on the object P.

In the print job, the motor controlling part 53 controls the CR motor 39 to cause the carriage 31 to reciprocate in the main scanning direction. The motor controlling part 53 calculates the voltage command value U so that the carriage 31 moves at constant velocity at the target velocity Vr in a region which is located between an acceleration region and a deceleration region in the moving route of the carriage 31, and in which the ink ejecting operation is performed.

Specifically, the motor controlling part 53 sequentially calculates the voltage command value U in accordance with the deviation E=Vr−V between the target velocity Vr of the carriage 31 and the detected velocity V of the carriage 31. The motor controlling part 53 sequentially inputs the calculated voltage command value U to the motor driver 70 to thereby cause the motor driver 70 to drive the CR motor 39 based on the voltage command value U. With this, the movement control of the carriage 31 is realized and the velocity of the carriage 31 is controlled to the target velocity Vr.

The main controlling part 51 generates observation data by sequentially recording, in the memory 513, the velocity V of the carriage 31 which is detected by using the linear encoder 40 and/or the voltage command value U as the operation amount U input to the motor driver 70 during a constant velocity period as a period in which the velocity of the carriage 31 is controlled to the target velocity Vr (step S120). The observation data is data in which the observed velocities V of the carriage 31 and/or the observed voltage command values U are arranged in a time series.

In a case where the print job is completed (step S130: YES), the main controlling part 51 performs frequency analysis of the velocities V and/or the voltage command values U in the constant velocity period indicated in the time series by the observation data (step S140). As a result of the frequency analysis, the frequency spectrum of the velocity V and/or the voltage command value U can be obtained. The main controlling part 51 causes the memory 513 to store the frequency spectrum (step S140).

The main controlling part 51 further identifies the peak of the velocity V and/or the peak of the voltage command value U in the constant velocity period indicated by the observation data, as an index value Z to be used for the determination of the remaining service life (step S150). The “identification” of the index value Z described here may include calculation of the index value Z. Namely, a procedure of identifying the index value Z may include calculation using the velocity V and/or the voltage command value U as an observed amount.

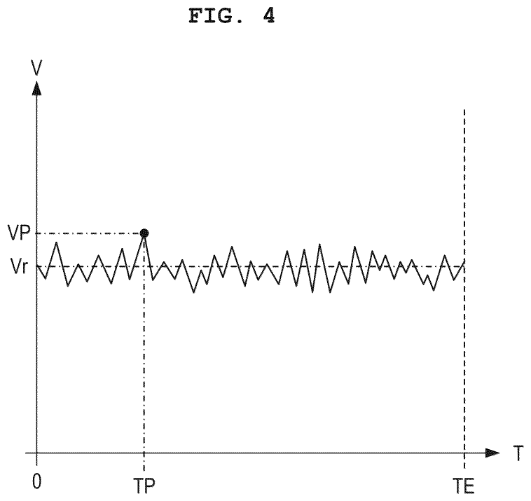

FIG. 4 is a graph having a horizontal axis representing time T and a vertical axis representing the velocity V, and which exemplifies a temporal change of the velocity V. According to this graph, in the constant velocity period in the print job (a period from time T=0 to time T=TE), the velocity V of the carriage 31 shows the maximum value VP at time TP.

The index value Z corresponds to a health index of the image forming system 1. According to the example depicted in FIG. 4, the main controlling part 51 identifies the maximum value VP of the velocity V, as the index value Z. FIG. 4, may be read as the graph exemplifying a temporal change of the operation amount U or the voltage command value U, rather than the velocity V. In this case, the main controlling part 51 is capable of identifying the maximum value of the voltage command value U as the index value Z.

After that, the main controlling part 51 registers the index value Z in a table for recording the index value (step S160), and ends the job-related process. The main controlling part 51 additionally records the index value Z in the table in the step S160 each time the main controlling part 51 executes the print job, thereby recording, in the table, time series data of the index value Z. Each time the main controlling part 51 executes the print job, the main controlling part 51 registers in the table the index value Z corresponding to the peak of the velocity V and/or the peak of the voltage command value U observed in the print job. The main controlling part 51 may record, in the table, information on the date and time of the recording, together with the index value Z.

Each time the main controlling part 51 executes the job-related process, the main controlling part 51 executes the determination-related process depicted in FIGS. 5A and 5B, following the job-related process. In the determination-related process, the remaining service life of the image forming system 1 is determined based on the changes in the index value Z indicated by the table (step S250); in a case where the remaining service life is short, the main controlling part 51 notifies the user of the remaining service life and the need for the maintenance (step S290).

In a case where the main controlling part 51 starts the determination-related process, the main controlling part 51 determines whether records of a predetermined number or more have been accumulated in the table (step S210). Here, the record means the record of the index value Z. In a case where the main controlling part 51 executes the job-related process a predetermined number of times or more, and the index values Z of the predetermined number or more have thereby been accumulated in the table, the main controlling part 51 makes a positive determination in the step S210, and executes a process of a step S220. On the other hand, in a case where the number of the index values Z accumulated in the table is less than the predetermined number (step S210: NO), the main controlling part 51 regards the information as insufficient and ends the determination-related process.

In the step S220, the main controlling part 51 determines whether the change amount of the index value is a reference or more. Specifically, the main controlling part 51 determines whether the latest value of the index value Z is lower than a previous value of the index value Z by the reference or more. In a case where the main controlling part 51 determines that the latest value of the index value Z is lower than the previous value by the reference or more (step S220: YES), the main controlling part 51 executes a process of a step S300. The index value Z improves sharply in a case where the maintenance is executed. The determination in the step S220 is performed to detect whether the index value Z is improved owing to the maintenance.

In a case where the main controlling part 51 determines that the change amount of the index value is less than the reference in the step 220 (step S220: NO), the main controlling part 31 executes a process of a step S230. In the step S230, the main controlling part 51 executes a smoothing process with respect to the time series data of the index value Z registered in the table, thereby generating the smoothed time series data of the index value Z. The smoothing process may specifically be a moving average process. The time series data of the index value Z is smoothed in the time direction by the moving average process.

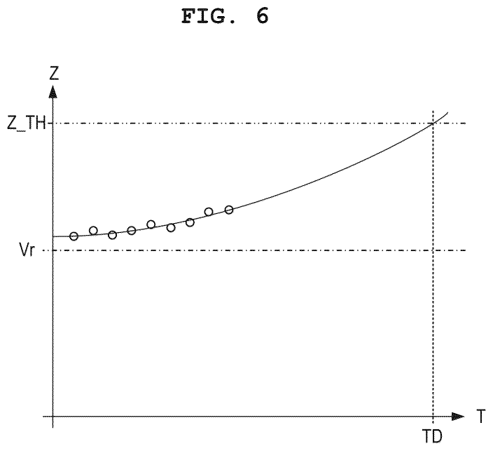

The main controlling part 51 then calculates an approximate curve of the index value Z by function fitting using a predetermined function with respect to the smoothed time series data of the index value Z (step S240). The graph indicated in FIG. 6 is a graph plotting the index value Z of each print job, based on the smoothed time series data of the index value Z. The graph has a horizontal axis representing time T and a vertical axis representing the index value Z.

The time T in the graph may be regarded as the number of times the print job has been executed. White circle dots in FIG. 6 correspond to plot points of the index value Z. In a case where each index value Z corresponds to the maximum value VP of the velocity Vin each print job, a group of the plot points represents temporal changes of the maximum value VP.

FIG. 6 describes an example in which an approximate curve of an exponential function corresponding to a group of the plot points is calculated by the function fitting using the exponential function. In FIG. 6, the approximate curve is represented by a solid line. The function fitting is performed, for example, so as to find an approximate curve in which the sum of squared errors regarding an error from the plot points is minimum.

Subsequently, in a step S250, the main controlling part 51 determines a remaining time until a time TD, when the index value Z on the approximate curve reaches a threshold value Z_TH, as the remaining service life. That is, the main controlling part 51 determines a time (e.g., the number of times the print job is to be executed) from the current time to the future time TD as the remaining service life. For example, a time from the latest plot point (a plot point located at an end of the time direction) to the time TD in FIG. 6 corresponds to the remaining service life. The threshold value Z_TH has such a meaning that the image forming system 1 is presumed to be out of order in a case where the index value Z exceeds the threshold value Z_TH. The threshold value Z_TH is set in advance via, for example, an operation test of the image forming system 1.

In a case where the index value Z corresponds to the maximum value VP of the velocity V of the carriage 31 in the print job, the threshold value Z_TH may correspond to the maximum value of the velocity V below which a normal velocity control can be performed. In a case where the index value Z corresponds to the maximum value of the voltage command value U in the print job, the threshold value Z_TH may be a voltage command value corresponding to the maximum value of the driving current which can be applied to the CR motor 39.

For example, in a case where the encoder scale 45 is dirtied by any stain adhered to the encoder scale 45 and the optical sensor 41 cannot read the gradations properly, the velocity V is likely to deviate from the target velocity Vr, and as the dirtiness in the encoder scale 45 spreads, the index value Z corresponding to the maximum value VP of the velocity V might reach the threshold value Z_TH. For example, in a case where a reaction force acting on the carriage 31 increases due to the malfunction of the carriage moving mechanism 30 caused by mechanical wear, the index value Z corresponding to the maximum value of the voltage command value U might reach the threshold value Z_TH.

Subsequently, in a step S260, the main controlling part 51 determines whether the determined remaining service life is the set value or less. The set value is defined so that the information urging the user to perform the maintenance can be output at an appropriate timing before the image forming system I reaches the end of the service life.

In a case where the main controlling part 51 determines that the remaining service life is the set value or less (step S260: YES), the main controlling part 51 sets an abnormality flag (step S270). The main controlling part 51 further identifies a part in the image forming system 1 of which service life has come to an end, based on the frequency spectrum of each of the plurality of print jobs accumulated in the memory 513 by the process of the step S140 (see FIG. 3). Accordingly, the main controlling part 51 identifies the cause of the change in the index value Z as the cause of the abnormality (step S280).

The main controlling part 51 identifies the cause of abnormality, for example, by comparing a target spectrum and a standard spectrum with each other, among the frequency spectra of the plurality of print jobs stored in memory 513 by the process of the step S140.

The target spectrum is a frequency spectrum which represents the current health status of the image forming system 1. Specifically, the target spectrum is a frequency spectrum of the speed V or of the voltage command value U based on the latest observation data obtained in the print job performed last.

The standard spectrum is a frequency spectrum in a case where the image forming system 1 operates normally and is presumed to has no abnormality occurred in the image forming system 1. Specifically, the standard spectrum is a frequency spectrum of the speed V or of the voltage command value U based on observation data obtained in a print job executed first or immediately after the maintenance.

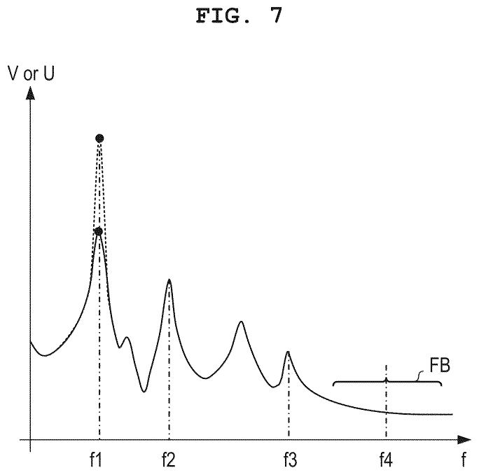

In FIG. 7, the target spectrum is represented by a broken line, and the standard spectrum is represented by a solid line. As indicated in the example in FIG. 7, each of the target spectrum and the standard spectrum has local peaks, in a first frequency band having a center frequency f1, a second frequency band having a center frequency f2, and a third frequency band having a center frequency f3. The frequency band indicated by a reference symbol FB in FIG. 7 corresponds to a fourth frequency band having a center frequency f4. The fourth frequency band is a wider frequency band than the first, second, and third frequency bands. The peak of the first frequency band of the target spectrum changes significantly in a direction in which the peak is raised from the peak of the first frequency band of the standard spectrum. In this situation, the main controlling part 51 identifies the part corresponding to the first frequency band as the cause of the abnormality.

In a case where the peak of the target spectrum has been changed by a predetermined amount or more from the peak of the standard spectrum in one of the first, second, third, and fourth frequency bands, the main controlling part 51 can identify a part corresponding to the one of the first, second, third, and fourth frequency bands as the cause of the abnormality. However, regarding the fourth frequency band, in a case where an abnormality is present, the spectral intensity might change widely throughout the entire frequency band, in some cases. Accordingly, in a case where the average value in the fourth frequency band of the target spectrum has changed by a predetermined amount or more from the average value in the fourth frequency band of the standard spectrum, the main controlling part 51 may identify the part corresponding to the fourth frequency band as the cause of the abnormality.

In a case where a change of the predetermined amount or more described above has occurred in two or more of the first, second, third, and fourth frequency bands, the main controlling part 51 can identify a part corresponding to a frequency band in which the change amount is the greatest among the two or more frequency bands as the cause of the abnormality.

For example, in a case where the first frequency band is related to the operation of the CR motor 39, the second frequency band is related to the operation of the rollers 311, the third frequency band is related to the operation of the belt mechanism 33, and the fourth frequency band is related to the operation of the linear encoder 40, the main controlling part 51 can identify the CR motor 39 as the cause of the abnormality, according to the example indicated in FIG. 7.

According to this example, the main controlling part 51 can identify in which one of the CR motor 39, rollers 311, the belt mechanism 33, and the linear encoder 40 an abnormality occurs, by comparing the target spectrum with the standard spectrum.

Subsequently, in a step S290, the main controlling part 51 displays, to the user via the user interface 90, the remaining service life determined in the step S250, and also displays, to the user via the user interface 90, information urging the user to perform the maintenance of the part corresponding to the cause of the abnormality identified in the step S280. After that, the main controlling part 51 ends the determination-related process depicted in FIGS. 5A and 5B.

By executing the determination-related process, the main controlling part 51 is capable of urging the user to execute the maintenance at an appropriate timing before the service life of each of the parts of the image forming system 1 comes to an end and results in the failure of the image forming system 1.

In the step S290, the main controlling part 51 is capable of outputting an alert sound via the user interface 90, thereby strongly urging the user to perform the maintenance. The user interface 90 may include a speaker (not depicted in the drawings) configured to output the alert sound.

On the other hand, in a case where the main controlling part 51 determines that the change amount of the index value is the reference or more in the step S220 (step S220: YES) or that the remaining service life is longer than the setting value in the step S260 (step S260: NO), the main controlling part 51 proceeds to the step S300. As another example, in a case where the main controlling part 51 makes a negative determination in the step S260, the main controlling part 51 may end the determination-related process, without executing the process of the step S300 and the process of a step S310. Alternatively, the main controlling part 51 may be configured to end the determination-related process, without executing the process of the step S300 and the process of the step S310 for a predetermined period after the abnormality flag is set.

In the step S300, the main controlling part 51 determines whether the abnormality flag is set. The abnormality flag is not set in the initial state and is set in the process of the step S270. In a case where the main controlling part 51 determines that the abnormality flag is not sct (step S300: NO), the main controlling part 51 ends the determination-related process.

On the other hand, in a case where the main controlling part 51 determines that the abnormality flag is set (step S300: YES), the main controlling part 51 considers that the maintenance has been completed and resets related data while resetting the abnormality flag (step S310). For example, the main controlling part 51 resets the table storing the time series data of the index value Z. After that, the main controlling part 51 ends the determination-related process.

According to the image forming system 1 of the present embodiment described above, each time the main controlling part 51 executes the print job, the main controlling part 51 generates, as the observation data, the time series data of the velocity V of the carriage 31 or the voltage command value U observed in the movement control of the carriage 31 during a concerning period (in particular, the constant velocity period). The main controlling part 51 further identifies the index value Z with respect to the abnormality in the image forming system 1 based on the observation date, each time the main controlling part 51 executes the print job.

The main controlling part 51 further determines the remaining service life of the image forming system 1, based on the changes in the index value Z over the plurality of print jobs. Specifically, the main controlling part 51 calculates the approximate curve regarding the changes in index value Z, and determines, as the end of the service life of the image forming system 1, the time TD in the future when the index value Z reaches the threshold value Z_TH on the approximate curve. Further, the main controlling part 51 determines, as the remaining service life of the image forming system 1, the time remaining until the time TD in the future arrives.

The main controlling part 51 calculates the above-described approximation curve by performing the function fitting on the time series data of the index value Z over the plurality of print jobs. In the above-described embodiment, the example in which the exponential function is applied as the approximation curve has been described. However, examples of the approximation curves include approximation straight lines. That is, the main controlling part 51 may calculate an approximation straight line by executing the function fitting using a linear function. The main controlling part 51 may execute the function fitting with respect only to the time series data of the latest index values Z of a predetermined number in order to suppress the influence of the old index values Z. The main controlling part 51 may execute the function fitting by weighting the index values Z. That is, the main controlling part 51 may execute the function fitting such that the newer the index value Z is, the greater the weight given to the index value is. The main controlling part 51 may execute the weighting, for example, with respect to the error between the index value Z and the approximate curve. The function fitting may be realized by finding an approximate curve in which the weighted error is minimum.

According to the present embodiment, by determining the remaining service life with the above-mentioned method, the time when the image forming system I might fail can be predicted with high accuracy, before the image forming system 1 fails, and the user can be urged to perform the maintenance of the image forming system 1 before the image forming system 1 fails. With this, the user can perform the maintenance of the image forming system 1 at an appropriate time before the image forming system 1 fails, thereby the occurrence or prolongation of the downtime associated with the failure can be reduced.

According to the present embodiment, the main controlling part 51 identifies, in particular, the maximum value (i.e., peak) of the detected velocity V of the carriage 31 or of the voltage command value U in the constant velocity period, as the index value Z. This index value Z corresponds to a feature amount of the concerning period. The maximum value VP of the detected velocity V corresponds to the moving velocity of the carriage at a timing when the moving velocity V of the carriage 31 deviates maximally from the target velocity Vr in the constant velocity period.

The main controlling part 51 soothes the time series data of the index value Z in the time direction by executing the moving average process. The main controlling part 51 uses the smoothed index value Z to calculate the approximate straight line and to determine the remaining service life. Therefore, according to the present embodiment, the influence of a minute variation in the index value Z can be reduced, the changes in the index value Z can be accurately grasped, and the remaining service life can be determined with high accuracy.

According to the present embodiment, the main controlling part 51 is further configured to perform a frequency analysis of the time series data of the velocity V or the voltage command value U so as to identify the cause of the abnormality in the image forming system 1. The main controlling part 51 identifies the cause of the abnormality in the image forming system 1 by comparing the frequency spectrum (the above-described target spectrum), which is obtained by performing the frequency analysis of the latest time series data in a case where the remaining service life becomes the set value or less, with the standard frequency spectrum (the above-described standard spectrum) which is presumed not to have any abnormality.

That is, the main controlling part 51 performs the frequency analysis of the time series data of the velocity V or of the voltage command value U in the constant velocity period, with respect to the latest print job and the first print job among the plurality of print jobs, and the main controlling part 51 compares the frequency spectra, respectively, of these two periods which are the latest and first print jobs. With this, the main controlling part 51 identifies the cause of the abnormality in the image forming system 1. The main controlling part 51 further displays, via the user interface 90, the information urging the user to perform the maintenance in accordance with the cause of the abnormality.

Therefore, the user can properly resolve the cause of the failure before a failure which is presumed to occur in the future actually occurs, by performing the maintenance in accordance with the display of the above-described information by the image forming system 1. As a result, the image forming system 1 is capable of effectively reducing the occurrence of the downtime due to the failure.

The image forming system 1 of the second embodiment will be described. Note that the image forming system 1 of the second embodiment differs from the image forming system 1 of the first embodiment only in that contents of the job-related process and the determination-related process executed by the main controlling part 51. Therefore, in the following, the contents of the job-related process and the determination-related process to be executed by the main controlling part 51 will be selectively described as the description regarding the image forming system 1 of the second embodiment. The image forming system 1 of the second embodiment is constructed in the same or the similar manner as the image forming system 1 of the first embodiment except for the configuration described below.

In the second embodiment, the main controlling part 51 executes the process of a step S155 instead of the process of the step S150, in the job-related process depicted in FIG. 3. In the step S140, the main controlling part 51 generates the frequency spectrum of the voltage command value U based on the observation data.

In the step S155, the main controlling part 51 identifies, as the index values Z, a peak of the spectrum intensity in each of a plurality of frequency bands defined in advance, based on the frequency spectrum of the voltage command value U obtained in the step S140.

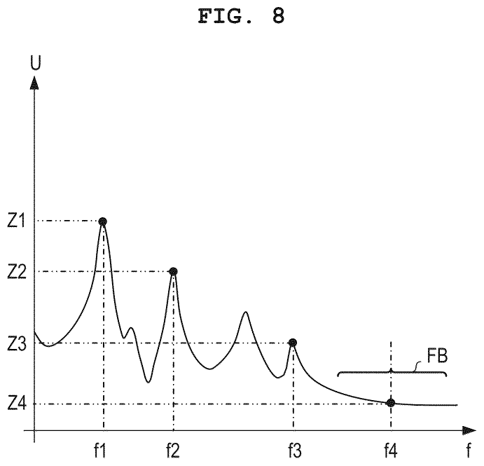

That is, as depicted in FIG. 8, the main controlling part 51 identifies, as a first index value Z1, the peak of the spectrum intensity in a first frequency band with a predetermined band width having the center frequency f1. The main controlling part 51 identifies, as a second index value Z2, the peak of the spectrum intensity in a second frequency band with a predetermined band width having the center frequency f2.

The main controlling part 51 identifies, as a third index value Z3, the peak of the spectrum intensity in a third frequency band with a predetermined band width having the center frequency f3. The main controlling part 51 identifies, as a fourth index value Z4, the peak (in other words, the maximum value) of the spectrum intensity in a fourth frequency band with a predetermined band width having the center frequency f4. Note that, regarding the fourth frequency band, the average of the spectrum intensity in the fourth frequency band may be calculated as the fourth index value Z4.

Then, the main controlling part 51 registers, as the index values Z, the index values Z1, Z2, Z3, and Z4 of the plurality of frequency bands in a table for index value recording. The main controlling part 51 registers time series data of each of the frequency bands, that is the time series data of each of the index values Z1, Z2, Z3, and Z4, in the table, by additionally registering the index values Z1, Z2, Z3, and Z4 in the table in the step S160, each time the main controlling part 51 executes the print-job.

That is, the main controlling part 51 registers, in the table, time series data of the peak (Z1) of the spectrum intensity in the first frequency band, time series data of the peak (Z2) of the spectrum intensity in the second frequency band, time series data of the peak (Z3) of the spectrum intensity in the third frequency band, and time series data of the peak (Z4) of the spectrum intensity in the fourth frequency band.

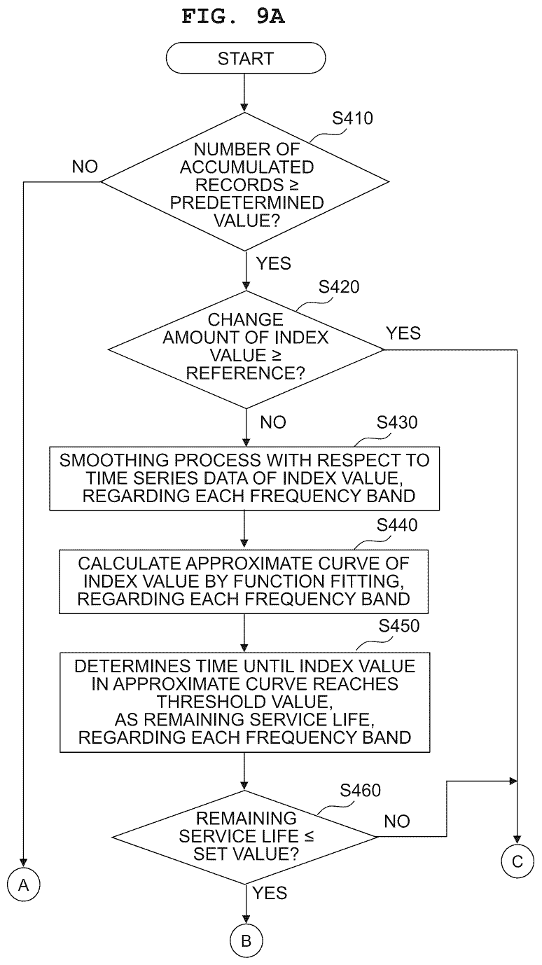

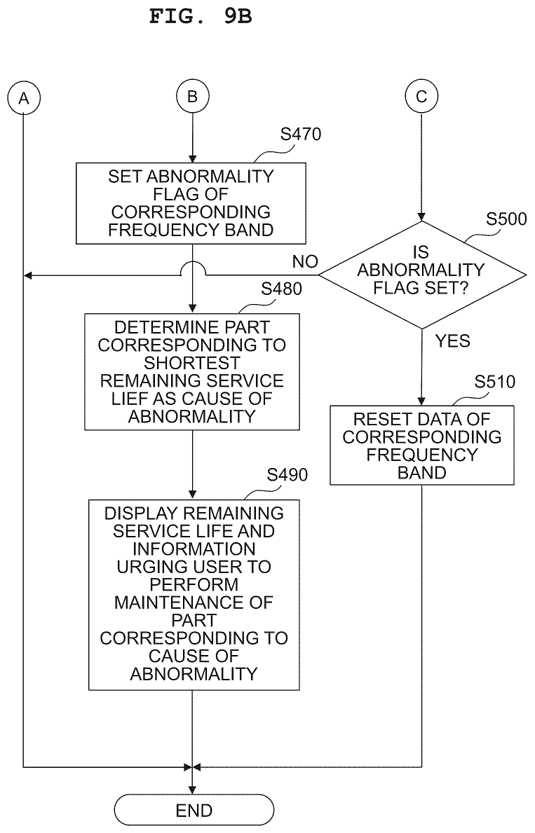

After executing the job-related process such as described above, the main controlling part 51 executes the determination-related process depicted in FIGS. 9A and 9B, instead of the determination-related process depicted in FIGS. 5A and 5B. After staring the determination-related process depicted in FIGS. 9A and 9B, the main controlling part 51 executes, in a step S410, a process similar to the process in the step S210 of the first embodiment. In a step S420 after the step S410, the main controlling part 51 determines whether a change amount of the index value is a reference or more.

Specifically, the main controlling part 51 performs, regarding each of the plurality of frequency bands, comparison between the corresponding index value Z (that is, one of the index values Z1, Z2, Z3, and Z4 corresponding to the frequency band in concern) and a previous value. In a case where the main controlling part 51 determines that the latest value of the index value Z has changed a reference or mote with respect to the previous value, the main controlling part 51 determines that the change amount of the index value is the reference or more. In a case where the main controlling part 51 determines that the change mount of the index value is the reference or more (step S420: YES), the main controlling part 51 executes a process of a step S500. On the other hand, in a case where the main controlling part 51 determines that the change amount of the index value is less than the reference (S420: NO), the main controlling part 51 executes a process of a step S430.

In the step S430, the main controlling part 51 generates, regarding each of the plurality of frequency bands, smoothed time series data of the index value Z by executing a smoothing process to the time series data of the corresponding index value Z. The smoothing process may be the moving average process, like the first embodiment.

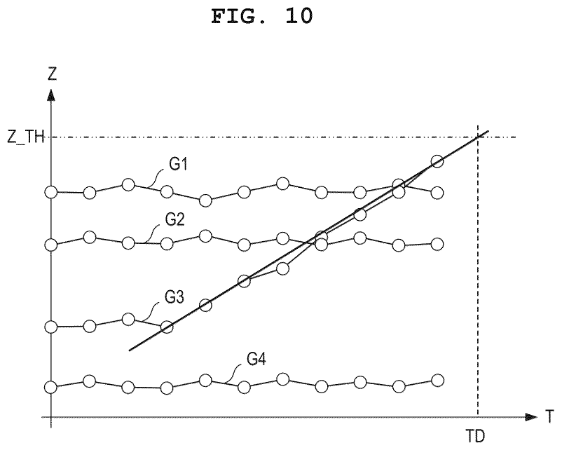

Then, the main controlling part 51 calculates, regarding each of the frequency bands, an approximate curve of the index value Z by function fitting to the smoothed time series data of the index value Z (step S440). The graph depicted in FIG. 10 is a graph plotting the index value Z of each print job, based on the smoothed time series data of the index value Z. The graph has a horizontal axis representing time T and a vertical axis representing the index value Z.

FIG. 10 describes an example in which an approximate curve of a linear function corresponding to a group of the plot points is calculated by the function fitting using the linear function. As another example, a quadratic function or an exponential function may be used instead of the linear function, in the function fitting. In this example, the main controlling part 51 executes the function fitting by using new index values Z of a predetermined number including the latest index value Z.

The first line graph G1 depicted in FIG. 10 is the graph based on the smoothed time series data of the first index value Z1. The second line graph G2 depicted in FIG. 10 is the graph based on the smoothed time series data of the second index value Z2. The third line graph G3 depicted in FIG. 10 is the graph based on the smoothed time series data of the third index value Z3. The fourth line graph G4 depicted in FIG. 10 is the graph based on the smoothed time series data of the fourth index value Z4.

In a step S450 after the step S440, the main controlling part 51 determines, regarding each of the plurality of frequency bands, a remaining time until the index value Z in the approximate curve reaches a threshold value Z_TH as a remaining service life. The threshold value Z_TH is defined independently for each of the plurality of frequency bands. That is, regarding the first frequency band, a first threshold value Z_TH1 for the first index value Z1 is defined. Regarding the second frequency band, a second threshold value Z_TH2 for the second index value Z2 is defined. Regarding the third frequency band, a third threshold value Z_TH3 for the third index value Z3 is defined. Regarding the fourth frequency band, a fourth threshold value Z_TH4 for the fourth index value Z4 is defined.

In a step S460 after the step S450, the main controlling part 51 determines the shortest remaining service life among the remaining service lives determined with respect to the plurality of frequency bands, respectively, and determines whether the shortest remaining service life is a set value or less. The remaining service life determined regarding each of the plurality of frequency bands is a remaining service life of a component in the image forming system 1 corresponding to the frequency band based on which the remaining service life is determined. The shortest remaining service life corresponds to the remaining service life of the image forming system 1. In a case where the main controlling part 51 determines that the remaining service life is the set value or less (step S460: YES), the main controlling part 51 set an abnormality flag of the frequency band corresponding to the shortest remaining service life.

In the second embodiment, the abnormality flag is provided for each of the plurality of frequency bands. The abnormality flag for each of the plurality of frequency bands is not set in an initial state. In the step S470, the main controlling part 51 selectively sets the abnormality flag of the frequency band corresponding to the shortest remaining service life among the plurality of abnormality flags described above (step S470).

The main controlling part 51 identifies a part corresponding to the frequency band showing the shortest remaining service life as a cause of the abnormality (S480). For example, a case where the first frequency band relates to an action of the CR motor 39, the second frequency band relates to an action of the rollers 311, the third frequency band relates to an action of the belt mechanism 33, and the fourth frequency band relates to an action of the linear encoder 40 will be considered.

In such a case, the main controlling part 51 identifies that the cause of the abnormality is the CR motor 39, in a case where the frequency band showing the shortest remaining service life is the first frequency band. The main controlling part 51 identifies that the cause of the abnormality is the rollers 311, in a case where the frequency band showing the shortest remaining service life is the second frequency band. The main controlling part 51 identifies that the cause of the abnormality is the belt mechanism 33, in a case where the frequency band showing the shortest remaining service life is the third frequency band. The main controlling part 51 identifies that the cause of the abnormality is the linear encoder 40, in a case where the frequency band showing the shortest remaining service life is the fourth frequency band.

In a step S490 after the step S480, the main controlling part 51 displays the remaining service life of the part corresponding to each of the plurality of frequency bands determined in the step S450 to the user via the user interface 90, and displays information urging the user to perform maintenance to the part corresponding the cause of the abnormality identified in the step S480 to the user via the user interface 90. Then, the main controlling part 51 ends the determination-related process depicted in FIGS. 9A and 9B.

By executing the determination-related process, the main controlling part 51 can urge the user to perform the maintenance at an appropriate timing before each part of the image forming system I reaches the end of the service life time and the image forming system 1 fails. In the step S490, the main controlling part 51 can output alert sound via the user interface 90 in addition to the display urging the user to perform the maintenance.

On the other hand, in a case where the main controlling part 51 determines that the change amount of the index value is the reference or more in the step S420 (step S420: YES) or determines that the shortest remaining service life is longer than the set value in the step S460 (S460: NO), the main controlling part 51 proceeds to a step S500. As another example, in a case where the main controlling part 51 makes negative determination in the step S460, the main controlling part 51 may end the determination-related process without executing the processes of the step S500 and a step S510.

In the step S500, the main controlling part 51 determines whether any one of the plurality of abnormality flags corresponding to the plurality of frequency bands is set. In a case where the main controlling part 51 determines that none of the plurality of flags is set (S500: NO), the main controlling part 51 ends the determination-related process.

On the other hand, in a case where the main controlling part 51 determines that any one of the plurality of flags is set (step S500: YES), the main controlling part 51 regards the maintenance corresponding to the set abnormality flag as having been completed. Thus, the main controlling part 51 resets the set abnormality flag, and resets data related to the set abnormality flag (step S510). After that, the main controlling part 51 ends the determination-related process.

The frequency band of which the number of the record of the index value Z has become less than a predetermined number by the resetting in the step S510 can be omitted from the object of the processes of the step S420 to the step S460 in the determination-related process to be executed thereafter, until the number of the record becomes the predetermined number or more. Alternatively, the main controlling part 51 may delete the records of all frequency bands from the table in the step S510.

In the image forming system 1 of the second embodiment described above, the main controlling part 51 performs the frequency analysis of the time series data of the voltage command value U of the concerning constant velocity period, each time when the main controlling part 51 executes the print job. Then, the main controlling part 51 identifies, regarding the plurality of components corresponding to the plurality of frequency bands, the index values Z1, Z2, Z3, and Z4 as the index values Z of the image forming system 1. The index values Z1, Z2, Z3, and Z4 correspond respectively to components different from each other.

Specifically, the main controlling part 51 identifies the index values Z1, Z2, Z3, and Z4 corresponding to the plurality of components constructing the carriage moving mechanism 30 (specifically, the CR motor 39, the rollers 311, and the belt mechanism 33) and the linear encoder 40. The index values Z1, Z2, Z3, and Z4 respectively corresponds to the frequency bands different from each other.

The main controlling part 51 determines the remaining service life of the image forming system 1 based on the changes of the index values Z1, Z2, Z3, and Z4 respectively correspond to the frequency bands different from each other, and by determining the remaining service life of the component, among the plurality of components, considered to reach the end of the service lift first.

In a case where the shortest remaining service life reaches the set value or less, the main controlling part 51 identifies the part corresponding to the shortest remaining service life as the cause of abnormality, and output information urging the user to perform the maintenance corresponding to the cause of abnormality via the user interface 90.

Thus, in the second embodiment, the user can appropriately resolve the cause of failure, before the failure expected to occur in future actually occurs, like the first embodiment. As a result, the image forming system 1 can reduce the occurrence of a down time due to failure effectively.

### OTHER EMBODIMENTS

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

For example, although the maximum value VP of the velocity V of the carriage 31 in the constant velocity period is identified as the index value Z in the first embodiment, the difference δ=|VP−Vr| being the difference between the maximum value VP and the target velocity Vr may be identified as the index value Z, instead of the maximum value VP.

In other words, the main controlling part 51 is capable of performing the smoothing process with respect to time series data of the difference δ and of performing the function fitting with respect to the time series data of the difference δ after the smoothing process. The main controlling part 51 may determine the remaining service life of the image forming system 1 by determining a time at which an approximate curve obtained by the above-described function fitting reaches a threshold value as the end of the service life of the image forming system 1.

Other than the above, the main controlling part 51 may execute the determination-related process in such a manner that the controlling part 51 executes the process of the step S270, S470 at a timing when the index values Z reaches a warning value or more rather than a timing when the remaining service life reaches the set value or less. The warning value is set as a value less than the threshold value Z_TH. For example, the process in the step S260 may be replaced with a process of determining whether the index value Z is the warning value or more. The process in the step S460 may be replaced with the process of determining whether any one of the index values Z1, Z2, Z3, and Z4 is the warning value or more. The warning value may be defined for each of the plurality of frequency band.

A part or whole of the job-related process and the determination-related process executed by the image forming system 1 may be executed by outside server apparatus 100 rather than by the image forming system 1. For realizing the above aspect, a computer program for causing the processor of the server apparatus 100 to execute a part or whole of the determination-related process may be prepared and may be installed into the server apparatus 100.

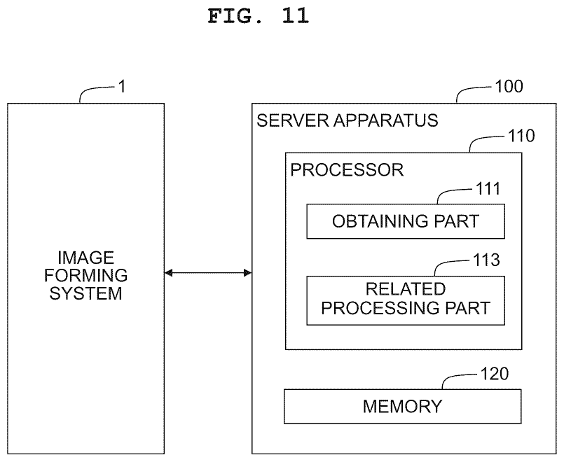

The server apparatus 100 depicted in FIG. 11 will be communicatively connected to the image forming system 1 via a wide area network. The server apparatus 100 includes a processor 110 and a memory 120. The processor 110 functions as an obtaining part 111 and a related processing part 113 by executing the process in accordance with the computer program stored in the memory 120.

The obtaining part 111 obtains observation data generated by the image forming system 1 in the step S120 each time the image forming system 1 executes the print job, through communication with the image forming system 1 from the image forming system 1. The related processing part 113 executes the process of the step S140, the process of the step S150 and the process of the step S160 of the job-related process depicted in FIG. 3, and the determination-related process depicted in FIGS. 5A and 5B or FIGS. 9A and 9B. Note, however, that in the step S290 or the step S490, the related processing part 113 transmits the information necessary for display to the image forming system 1 and causes the user interface 90 of the image forming system 1 to display corresponding information. The server apparatus 100 may be configured such that the user can confirm the corresponding information on a browser.

In addition, in the above-described embodiment, the main controlling part 51 identifies the index value Z each time the main controlling part 51 executes a print job, generates the time series data of the index value Z, and determines the remaining service life based on the time series data. Note, however, that the main controlling part 51 may generate the index value Z in each predetermined period, such as each day, rather than in each print job.

For example, the main controlling part 51 may identify the maximum value of all of the velocities V or all of the voltage command values U in the constant velocity periods of the print jobs executed in a day as the index value Z. The situation realized by such aspect can also be realized by identifying the index value Z for each print job, and summarizing the index value Z of the time series data daily basis in the step S230, S430 of the determination related process.

That is, the time series data of the index value obtained print job by print job basis can be converted into the time series data of the index value of day by day basis by statistical processing or thinning. The thinning can be realized by deleting the index values Z other than the maximum index value Z of the day.

The index value Z can be identified at various timing, without being limited to print job by print job basis or day by day basis. For example, the index value may be identified weekly, monthly, or each time when the image forming system 1 is activated, and the like. Other than above, the image forming system 1 of the above embodiment may be applied to ink-jet printer other than a garment printer.

Further, a parameter different from the above-described velocity V or the voltage command value U as the operation amount may be used to identify the index value Z. The voltage command value U corresponds to the motor torque and to the acceleration of the carriage 31. Therefore, the index value Z may be identified by using, instead of the velocity V, a peak of the acceleration as a physical amount calculated from the velocity V. The acceleration is time derivative of the velocity V and is related to the velocity V. The observation data generated in the step S120 may include the data in which the observed accelerations of the carriage 31 are arranged in a time series. The acceleration may be of an absolute value.

A function of one constituent component in the above-described embodiment may be distributed in a plurality of constituent components. Functions of a plurality of constituent components in the above-described embodiment may be integrated into one constituent component. A part of the configuration of the above-described embodiment may be omitted. At least a part of the configuration of the above-described embodiment may be added to or replaced by another configuration of the above-described embodiment. Every aspect encompassed by the technical concept identified from the wording of the claims is an embodiment of the present disclosure.

### (Technical Concept Disclosed by the Specification)

The present specification can be appreciated as disclosing, for example, the following technical concepts.

### (Item 1)

An image forming system comprising:
a recording head configured to eject an ink to a recording medium;
a carriage moving mechanism including:
   a carriage on which the recording head is mounted;
   a motor; and
   a transmission configured to move the carriage in a main scanning direction by converting rotational motion of the motor into translational motion of the carriage;
a motor driver configured to drive the motor;
an encoder configured to output an encoder signal corresponding to a positional change of the carriage in the main scanning direction; and
a controller configured to perform moving control of the carriage by inputting an operation amount for moving the carriage in the main scanning direction at a target velocity into the motor driver based on a moving velocity of the carriage detected based on the encoder signal, wherein:
the motor driver is configured to apply a driving power based on the operation amount to the motor so as to drive the motor;
the controller is configured to:
identify, regarding a certain period being each of the plurality of periods, an index value regarding abnormality of the image forming system based on time series data of the moving velocity, a physical amount related to the moving velocity, or the operation amount observed in the moving control of the carriage in the certain period; and
determine an end of a service life of the image forming system or a remaining amount of the service life of the image forming system based on a change of the index value over the plurality of periods.

### (Item 2)

The image forming system according to item 1, wherein the controller is configured to calculate an approximate curve regarding the change of the index value, and determine a future point in time at which the index value on the approximate curve reaches a threshold value as the end of the service life of the image forming system.

### (Item 3)

The image forming system according to item 2, wherein the controller is configured to calculate the approximate curve by executing a function fitting to the index value of the plurality of periods by using a predetermined function.

### (Item 4)

The image forming system according to any one of items 1 to 3, wherein the controller is configured to:
identify, regarding the certain period being each of the plurality of periods, a peak of the operation amount in the certain period, or the moving velocity of the carriage or a difference between the moving velocity of the carriage and the target velocity at a timing when the moving velocity of the carriage most deviates from the target velocity in the certain period as a feature amount of the certain period; and
calculate the index value as a value obtained by smoothing the feature amount in a time direction.

### (Item 5)

The image forming system according to any one of items 1 to 4, wherein the controller is further configured to identify a cause of abnormality of the image forming system by performing a frequency analysis of the time series data.

### (Item 6)

The image forming system according to item 5, wherein the controller is configured to identify the cause of the abnormality of the image forming system by comparing a frequency spectrum obtained by the frequency analysis of the time series data being latest with a standard frequency spectrum, in a case where the index value or the remaining amount of the service life satisfies a predetermined condition,
wherein the standard frequency spectrum is a frequency spectrum obtained in a case where the image forming system is in a normal state.

### (Item 7)

The image forming system according to any one of items 1 to 4, wherein the controller is further configured to:
perform, regarding the certain period being each of at least two periods of the plurality of periods, a frequency analysis of the time series data of the certain period; and
identify a cause of abnormality of the image forming system by comparing frequency spectrums of the at least two periods with each other.

### (Item 8)

The image forming system according to any one of items 5 to 7, wherein:
the carriage moving mechanism includes a guide rail;
the carriage includes an interface with respect to the guiderail for running on the guiderail, the carriage being configured to run on the guiderail by a force from the motor transmitted via the transmission; and
the controller is configured to identify the cause of the abnormality by identifying in which of the motor, the interface, the transmission, and the encoder abnormality exists.

### (Item 9)

The image forming system according to any one of items 1 to 5, wherein the controller is configured to:
perform, regarding the certain period being each of the plurality of periods, a frequency analysis of the time series data of the certain period; and
identify index values regarding abnormality of a plurality of components corresponding respectively to a plurality of frequency bands of a frequency spectrum as the index value of the image forming system, based on the frequency spectrum of each of the plurality of frequency bands, the plurality of components being components constructing the encoder and the carriage moving mechanism.

### (Item 10)

The image forming system according to item 9, wherein the controller determines the end of the service life of the image forming system or the remaining amount of the service life of the image forming system, by determining an end of a service life or a remaining amount of the service life of a component of the plurality of components which reaches the end of the service life first, based on a change in the index value of each of the components.

### (Item 11)

The image forming system according to any one of items 1 to 10, wherein:
the operation amount is a voltage command value; and
the motor driver is configured to drive the motor by applying the driving power based on the voltage command value to the motor.

### (Item 12)

A determining method for determining an end of a service life of an image forming system or a remaining amount of the service life of the image forming system, the image forming system including:
a recording head configured to eject an ink to a recording medium;
a carriage moving mechanism including:
   a carriage on which the recording head is mounted;
   a motor; and
   a transmission configured to move the carriage in a main scanning direction by converting rotational motion of the motor into translational motion of the carriage;
a motor driver configured to drive the motor;
an encoder configured to output an encoder signal corresponding to a positional change of the carriage in the main scanning direction; and
a controller configured to perform moving control of the carriage by inputting an operation amount for moving the carriage in the main scanning direction at a target velocity into the motor driver based on a moving velocity of the carriage detected based on the encoder signal, wherein:
the motor driver is configured to apply a driving power based on the operation amount to the motor so as to drive the motor;
the determining method comprising:
obtaining, regarding a certain period being each of the plurality of periods, time series data of the moving velocity, a physical amount related to the moving velocity, or the operation amount observed in the moving control of the carriage in the certain period, and identifying an index value regarding abnormality of the image forming system based on the time series data; and
determining the end of the service life of the image forming system or the remaining amount of the service life of the image forming system based on a change of the index value over the plurality of periods.

### (Item 13)

The determining method according to item 12, wherein the determining of the end of the service life of the image forming system or the remaining amount of the service life of the image forming system includes:
calculating an approximate curve regarding the change of the index value, and
determining a future point in time at which the index value on the approximate curve reaches a threshold value as the end of the service life of the image forming system.

### (Item 14)

The determining method according to item 13, wherein the determining of the end of the service life of the image forming system includes calculating the approximate curve by executing a function fitting to the index value of the plurality of periods by using a predetermined function.

### (Item 15)

The determining method according to any one of items 12 to 14, wherein the identifying of the index value includes:
identifying, regarding the certain period being each of the plurality of periods, a peak of the operation amount in the certain period, or the moving velocity of the carriage or a difference between the moving velocity of the carriage and the target velocity at a timing when the moving velocity of the carriage most deviates from the target velocity in the certain period as a feature amount of the certain period; and
calculating the index value as a value obtained by smoothing the feature value in a time direction.

### (Item 16)

The determining method according to any one of items 12 to 15, further comprising identifying a cause of abnormality of the image forming system by performing a frequency analysis of the time series data.

### (Item 17)

The determining method according to item 16, wherein:
the carriage moving mechanism includes a guide rail;
the carriage includes an interface with respect to the guiderail for running on the guiderail, the carriage being configured to run on the guiderail by a force from the motor transmitted via the transmission; and
the determining of the cause of the abnormality includes identifying the cause of the abnormality by identifying in which of the motor, the interface, the transmission, and the encoder abnormality exists.

### (Item 18)

A computer program for causing a computer to execute the determining method as defined in any one of items 12 to 17.

### (Item 19)

A computer readable recording medium storing a computer program as defined in item 18.

What is claimed is:

1. An image forming system comprising:
a head;
a carriage moving mechanism including:
a carriage on which the head is mounted;
a motor; and
a transmission connected to the carriage and the motor;
a motor driver;
an encoder; and
a controller, wherein:
the controller is configured to perform moving control of the carriage by inputting an operation amount for moving the carriage in a main scanning direction at a target velocity into the motor driver based on a moving velocity of the carriage detected based on an encoder signal output from the encoder;
the motor driver is configured to apply a driving power based on the operation amount to the motor so as to drive the motor; and
the controller is further configured to:
identify, regarding a certain period being each of the plurality of periods, an index value regarding abnormality of the image forming system based on time series data of the moving velocity, a physical amount related to the moving velocity, or the operation amount observed in the moving control of the carriage in the certain period; and
determine an end of a service life of the image forming system or a remaining amount of the service life of the image forming system based on a change of the index value over the plurality of periods.

2. The image forming system according to claim 1, wherein the controller is configured to calculate an approximate curve regarding the change of the index value, and determine a future point in time at which the index value on the approximate curve reaches a threshold value as the end of the service life of the image forming system.

3. The image forming system according to claim 2, wherein the controller is configured to calculate the approximate curve by executing a function fitting to the index value of the plurality of periods by using a predetermined function.

4. The image forming system according to claim 1, wherein the controller is configured to:
identify, regarding the certain period being each of the plurality of periods, a peak of the operation amount in the certain period, or the moving velocity of the carriage or a difference between the moving velocity of the carriage and the target velocity at a timing when the moving velocity of the carriage most deviates from the target velocity in the certain period as a feature amount of the certain period; and
calculate the index value as a value obtained by smoothing the feature amount in a time direction.

5. The image forming system according to claim 1, wherein the controller is further configured to identify a cause of abnormality of the image forming system by performing a frequency analysis of the time series data.

6. The image forming system according to claim 5, wherein the controller is configured to identify the cause of the abnormality of the image forming system by comparing a frequency spectrum obtained by the frequency analysis of the time series data being latest with a standard frequency spectrum, in a case where the index value or the remaining amount of the service life satisfies a predetermined condition,
wherein the standard frequency spectrum is a frequency spectrum obtained in a case where the image forming system is in a normal state.

7. The image forming system according to claim 1, wherein the controller is further configured to:
perform, regarding the certain period being each of at least two periods of the plurality of periods, a frequency analysis of the time series data of the certain period; and
identify a cause of abnormality of the image forming system by comparing frequency spectrums of the at least two periods with each other.

8. The image forming system according to claim 5, wherein:
the carriage moving mechanism includes a guide rail;
the carriage includes an interface with respect to the guiderail for running on the guiderail, the carriage being configured to run on the guiderail by a force from the motor transmitted via the transmission; and
the controller is configured to identify the cause of the abnormality by identifying in which of the motor, the interface, the transmission, and the encoder abnormality exists.

9. The image forming system according to claim 1, wherein the controller is configured to:
perform, regarding the certain period being each of the plurality of periods, a frequency analysis of the time series data of the certain period; and
identify index values regarding abnormality of a plurality of components corresponding respectively to a plurality of frequency bands of a frequency spectrum as the index value of the image forming system, based on the frequency spectrum of each of the plurality of frequency bands, the plurality of components being components constructing the encoder and the carriage moving mechanism.

10. The image forming system according to claim 9, wherein the controller is configured to determine the end of the service life of the image forming system or the remaining amount of the service life of the image forming system, by determining an end of a service life or a remaining amount of the service life of a component of the plurality of components which reaches the end of the service life first, based on a change in the index value of each of the components.

11. The image forming system according to claim 1, wherein:
the operation amount is a voltage command value; and
the motor driver is configured to drive the motor by applying the driving power based on the voltage command value to the motor.

12. A determining method for determining an end of a service life of an image forming system or a remaining amount of the service life of the image forming system, the image forming system including:
a head;
a carriage moving mechanism including:
a carriage on which the head is mounted;
a motor; and
a transmission connected to the carriage and the motor;
a motor driver;
an encoder; and
a controller, wherein:
the controller is configured to perform moving control of the carriage by inputting an operation amount for moving the carriage in the main scanning direction at a target velocity into the motor driver based on a moving velocity of the carriage detected based on the encoder signal output from the encoder; and
the motor driver is configured to apply a driving power based on the operation amount to the motor so as to drive the motor,
the determining method comprising:
obtaining, regarding a certain period being each of the plurality of periods, time series data of the moving velocity, a physical amount related to the moving velocity, or the operation amount observed in the moving control of the carriage in the certain period, and identifying an index value regarding abnormality of the image forming system based on the time series data; and
determining the end of the service life of the image forming system or the remaining amount of the service life of the image forming system based on a change of the index value over the plurality of periods.

13. The determining method according to claim 12, wherein the determining of the end of the service life of the image forming system or the remaining amount of the service life of the image forming system includes:
calculating an approximate curve regarding the change of the index value, and
determining a future point in time at which the index value on the approximate curve reaches a threshold value as the end of the service life of the image forming system.

14. The determining method according to claim 13, wherein the determining of the end of the service life of the image forming system includes calculating the approximate curve by executing a function fitting to the index value of the plurality of periods by using a predetermined function.

15. The determining method according to claim 12, wherein the identifying of the index value includes:
identifying, regarding the certain period being each of the plurality of periods, a peak of the operation amount in the certain period, or the moving velocity of the carriage or a difference between the moving velocity of the carriage and the target velocity at a timing when the moving velocity of the carriage most deviates from the target velocity in the certain period as a feature amount of the certain period; and
calculating the index value as a value obtained by smoothing the feature value in a time direction.

16. The determining method according to claim 12, further comprising identifying a cause of abnormality of the image forming system by performing a frequency analysis of the time series data.

17. The determining method according to claim 16, wherein:
the carriage moving mechanism includes a guide rail;
the carriage includes an interface with respect to the guiderail for running on the guiderail, the carriage being configured to run on the guiderail by a force from the motor transmitted via the transmission; and
the determining of the cause of the abnormality includes identifying the cause of the abnormality by identifying in which of the motor, the interface, the transmission, and the encoder abnormality exists.

18. A non-transitory and computer-readable medium storing a program for causing a computer to execute the determining method as defined in claim 12.
